(19) United States
(12) Patent Application Publication
(10) Pub. No.: US 2006/0190535 A1
(43) Pub. Date: Aug. 24, 2006

(54) Method, subject terminal device, target terminal device, data content server, system and computer programs for maintaining and updating data contents

(75) Inventors: Juha Kaitaniemi, Tampere (FI); Mauno Pasanen, Ruutana (FI); Tetsuro Tachizawa, Tampere (FI); Janne Julkunen, San Diego, CA (US); Pasi Pikkarainen, Oulu (FI); Veli-Pekka Uotinen, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/408,980

(22) Filed: Apr. 24, 2006

Related U.S. Application Data
(63) Continuation of application No. PCT/FI03/00879, filed on Nov. 18, 2003.

(51) Int. Cl. G06F 15/16

(52) U.S. Cl. 709/203; 707/3

(57) ABSTRACT

The invention discloses a method, system, target terminal device, subject terminal device and computer programs for maintaining and updating data contents in at least one data content server and target terminal device. In one embodiment, a data content change relating to a subject terminal device is detected in a data content server. The data content server transmits an identifier to at least one target terminal device. If the at least one target terminal device has data content corresponding to the received identifier in its memory, it may use it. If such a data content corresponding to the received identifier is not found in its memory, the at least one target terminal device requests the changed data content from the data content server.

### FIELD OF THE INVENTION

The present invention relates to mobile telecommunication systems. In particular, the present invention relates to a novel and improved method, target terminal device, system and computer programs for updating data contents in at least one of a target terminal device and a data content server.

### BACKGROUND OF THE INVENTION

In the Internet there are applications that can be used to transmit presence information to other users. A presence application is typically a network server application although the user has to have a client application. The network server application maintains e.g. a database comprising state information of a plurality of users. Other users can acquire e.g. state information of a user or, alternatively, a user may be able to determine to whom his/her state information can be delivered. The user may also state that he/she is e.g. absent, engaged etc. at the moment so that another user willing to contact him/her has further information about the state of the user. The state of a user may also be indicated by using a special logo or a graphic figure.

The same idea of presence applications has been adopted also to mobile telecommunication networks. Leading mobile device and network suppliers, operators, information technology companies and content providers formed the Open Mobile Alliance (OMA) in June 2002. The Open Mobile Alliance is designed to be the center of mobile service standardization work, helping the creation of interoperable services across countries, operators and mobile terminals that will meet the needs of the user. To grow the mobile market, the companies supporting the Open Mobile Alliance will work towards stimulating the fast and wide adoption of a variety of new, enhanced mobile information, communication and entertainment services.

The purpose of the Open Mobile Alliance is to grow the market for the entire mobile industry by removing barriers to interoperability, supporting a seamless and easy to use mobile experience for users and a market environment that encourages competition through innovation and differentiation.

In wireless networks, the term presence takes on a richer meaning. It includes e.g. client device availability, user status, location, client device capabilities and searchable personal statuses, such as mood and hobbies.

Some mobile terminal applications require transfer of content data between a network (presence) server and a mobile terminal. In some cases the content to be transferred is such that the same content is transferred frequently to the same terminal. An example of this kind of terminal application is the Presence Enhanced Contacts, which displays user's presence information using different logos. When a user A publishes his/her presence logo from his/her terminal, the logo will be transferred to a presence server, which then transfers it as a presence notification to the terminals of other users who have subscribed to user A's presence information.

When users publish their presence logos, it is likely that the same logo images are used by different users and, typically, more than once by a single user.

FIG. 1 discloses one solution for updating presence information via a presence server. FIG. 1 comprises a sending user terminal 14, a presence server 18 and three receiving user terminals 16a, 16b and 16c. User terminals 14, 16a, 16b and 16c are connected to presence server 18. User terminal 14 sends a presence update message including an image to presence server 18, as indicated with arrow 10. With the presence update message including the image the user of the terminal 14 indicates that his/her status has changed. The current status may be e.g. that he/she is now in an important meeting and will not answer to any phone calls. The size of the presence update message may be several kbytes, e.g. 5 kbytes. In FIG. 1, three users (of user terminals 16a, 16b and 16c) have subscribed to presence information of the user of user terminal 14. Therefore, presence notifications with the image are sent from presence server 18 to user terminals 16a, 16b and 16c, as indicates with arrow 12.

The above solution results in a problem that when frequently transferring same data contents to mobile terminals, unnecessary network load and unnecessary delays are created. The same problem applies to a situation in which mobile terminals send data content updates to a presence server.

The problem is currently solved so that updated or changed data contents are transferred to mobile terminals multiple times, since a mobile terminal and a network server are not aware of what data content has been transferred earlier.

### SUMMARY OF THE INVENTION

According to a first aspect of the invention there is provided a method of updating data contents in at least one data content server. The method comprises the steps of sending a data content change message from a subject terminal device to at least one data content server, the data content change message comprising an identifier for the changed data content; and determining in the at least one data content server, based on the received identifier for the changed data content, whether data content corresponding to the identifier already exists in its memory. If the data content corresponding to the identifier does not exist in the memory of the at least one data content server, the method further comprises the steps of requesting the changed data content from the subject terminal device, and transmitting the changed data content from the subject terminal device to the at least one data content server. If the data content corresponding to the identifier exists in the memory of the at least one data content server, the method further comprises the step of using the data content corresponding to the received identifier.

In one embodiment of the invention, the identifier for the changed data content is calculated by the subject terminal device using a hash code function.

According to a second aspect 6f the invention there is provided a method of updating data contents in at least one target terminal device. The method comprises the steps of detecting a data content change relating a subject terminal device, transmitting an identifier for a changed data content to at least one target terminal device, receiving the transmitted identifier with the at least one target terminal device, and determining in the at least one target terminal device, based on the received identifier for the changed data content, whether data content corresponding to the identifier already exists in its memory. If the data content corresponding to the identifier does not exist in the memory of the at least one target terminal device, the method further comprises the steps of requesting, by the at least one target terminal device, the changed data content from the at least one data content server, and transmitting the changed data content from the at least one data content server to the at least one target terminal device. If the data content corresponding to the identifier already exists in the memory of the at least one target terminal device, the method further comprises the step of using the data content corresponding to the received identifier.

In one embodiment of the invention, the identifier is a hash code.

For further characteristics of this aspect of the invention, reference is made to the claims.

According to a third aspect of the invention there is provided a target terminal device comprising a first memory, a first receiver configured to receive an identifier for a changed data content, first determining means configured to determine, based on the received identifier for the changed data content, whether data content corresponding to the identifier content already exists in the first memory, a first transmitter configured to transmit a request for the changed data content if data content corresponding to the identifier does not exist in the first memory, wherein the receiver is configured to receive the requested changed data content, and applying means configured to use the data content in the first memory the identifier of which corresponds to the received identifier if the changed data content exists in the first memory, or to use the received changed data content received by the receiver if the changed data content does not exist in the memory.

In one embodiment of the invention, the identifier is a hash code.

In one embodiment of the invention, the target terminal device comprises a mobile phone.

For further characteristics of this aspect of the invention, reference is made to the claims.

According to a fourth aspect of the invention there is provided a data content server for maintaining and updating data content information. The server comprises a second memory configured to store a plurality of data contents, a second receiver configured to receive a data content change message from a subject terminal device, the data content message comprising at least one of a changed data content and an identifier for the changed data content, and a second transmitter configured to transmit the identifier for the changed data content to at least one target terminal device.

In one embodiment of the invention, the data content server further comprises second determining means configured to determine, based on the received identifier for the changed data content, whether data content corresponding to the identifier already exists in the second memory. If the data content corresponding to the identifier does not exist in the second memory, the second transmitter is configured to request the changed data content from the subject terminal device, and the second receiver is configured to receive the changed data content from the subject terminal device. If the data content corresponding to the identifier exists in the second memory, the second transmitter is configured to transmit the identifier for the changed data content to at least one target terminal device.

In one embodiment of the invention, the second receiver is configured to receive a request for the changed data content from the at least one target terminal device, and the second transmitter is configured to transmit the changed data content to the at least one target terminal device.

In one embodiment of the invention, the second determining means are configured to calculate an identifier for the changed data content using a hash code function.

According to a fifth aspect of the invention there is provided a system of maintaining and updating data contents in communication network, comprising at least one data content server; at least one subject terminal device connected to the at least data content server; at least one target terminal device connected to the at least data content server; the at least one target terminal device comprising a first memory; a first receiver configured to receive an identifier for a changed data content; first determining means configured to determine, based on the received identifier for the changed data content, whether data content corresponding to the identifier already exists in the first memory; a first transmitter configured to transmit a request for the changed data content if data content corresponding to the identifier does not exist in the first memory, wherein the first receiver is configured to receive the requested changed data content; and applying means configured to use the data content in the first memory the identifier of which corresponds to the received identifier if the changed data content exists in the first memory, or to use the received changed data content received by the first receiver if the changed data content does not exist in the first memory; and the at least data content server comprising a second memory configured to store a plurality of data contents; a second receiver configured to receive a data content change message from the at least one subject terminal device, the data content change message comprising at least one of a changed data content and an identifier for the changed data content; and a second transmitter configured to transmit the identifier for the changed data content to the at least one target terminal device.

In one embodiment of the invention, creating means are configured to create an identifier for the changed data content using a hash code function.

In one embodiment of the invention, the at least one of the subject terminal device and target terminal devices comprise a mobile phone.

For further characteristics of this aspect of the invention, reference is made to the claims.

According to a sixth aspect of the invention there is provided a subject terminal device, comprising a third memory; third determining means configured to determine an identifier for a changed data content; a third transmitter configured to transmit a data content change message to a data content server, the data content change message comprising the identifier for the changed data content; and a third receiver configured to receive a request for the changed data content if data content corresponding to the identifier does not exist in the memory of the data content server, wherein the transmitter is configured to transmit the changed data content stored in the third memory to the at least one data content server.

In one embodiment of the invention, the third determining means are configured to calculate an identifier for the changed data content using a hash code function.

In one embodiment of the invention, the subject terminal device comprises a mobile phone.

According to a seventh aspect of the invention there is provided a computer program comprising code adapted to perform the following steps when executed on a data-processing system: detecting a data content change relating to a subject terminal device; and transmitting an identifier for the changed data content to at least one target terminal device.

In one embodiment of the invention, the computer program is stored on a computer readable medium.

For further characteristics of this aspect of the invention, reference is made to the claims.

According to a eight aspect of the invention there is provided a computer program comprising code adapted to perform the following steps when executed on a data-processing system: receiving an identifier for a changed data content from a data content server; and determining, based on the received identifier for the changed data content, whether data content corresponding to the identifier already exists in a memory; wherein if the data content corresponding to the identifier does not exist in the memory, requesting the changed data content corresponding to the received identifier from the data content server; and wherein if the data content corresponding to the identifier already exists in the memory, using the data content corresponding to the received identifier.

In one embodiment of the invention, the computer program further comprises code adapted to perform the following steps when executed on said data-processing system: calculating at least one identifier for data contents stored in the memory of the at least one target terminal device; and comparing the calculated at least one identifier to the received identifier.

In one embodiment of the invention, the step of determining comprising comparing the received identifier to at least one identifier stored in the memory of the at least one target terminal device.

In one embodiment of the invention, the computer program is stored on a computer readable medium.

In one embodiment of the invention, the identifier comprises a hash code.

According to a ninth aspect of the invention there is provided a computer program comprising code adapted to perform the following step when executed on a data-processing system: sending a data content change message comprising an identifier for the changed data content to a data content server.

In one embodiment of the invention, the computer program further comprises code adapted to perform the following step when executed on said dataprocessing system: calculating the identifier for the changed data content using a hash code function.

In one embodiment of the invention, the computer program further comprises code adapted to perform the following steps when executed on said data-processing system: receiving a request for the changed data content from the data content server; and transmitting the changed data content to the data content server.

In one embodiment of the invention, the computer program is stored on a computer readable medium.

The present invention has several advantages over the prior art solutions. For example, network load is significantly reduced, and the terminal device application offers better usability since data content does not have to be waited from the network because it is already available in the terminal is device.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

(Prior art) FIG. 1 illustrates a solution for updating data contents in target terminal devices,

FIG. 2 illustrates one embodiment for updating data contents in a target terminal device in accordance with the invention,

FIG. 3 illustrates another embodiment for updating data contents in a data server and a target terminal device in accordance with the invention,

FIG. 4 is a block diagram illustrating one embodiment of the method in accordance with the invention,

FIG. 5 is a block diagram illustrating another embodiment of the method in accordance with the invention,

FIG. 6a is a block diagram illustrating one embodiment of the system in accordance with the invention, and

FIG. 6b is a block diagram illustrating another embodiment of the system in accordance with the invention.

### DETAILED DESCRIPTION OF THE INVENTION

Reference will now be made in detail to the embodiments of the present invention, examples of which are illustrated in the accompanying drawings.

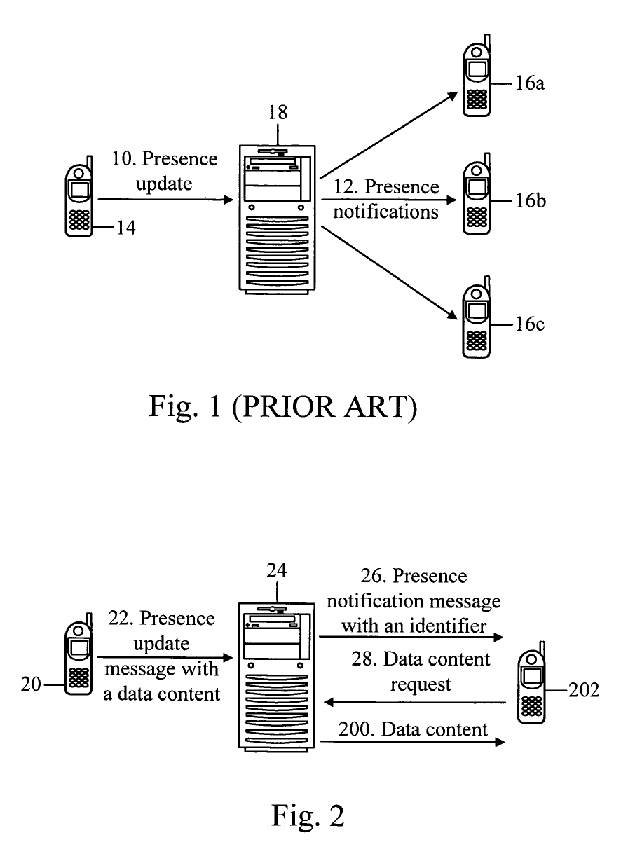

FIG. 2 discloses one embodiment illustrating a simplified solution for updating presence information via a presence server in accordance with the invention.

FIG. 2 comprises a sending user terminal 20, a presence server 24 and a receiving user terminal 202. User terminals 20 and 202 are connected to presence server 24. It must be noted that FIG. 2 discloses only one sending and receiving user terminal. In other embodiments, there may be any other number of them.

Sending user terminal 20 sends a presence update message including e.g. an image to presence server 24, as indicated with arrow 20. The image is e.g. a presence logo. With the presence update message the user of user terminal 20 indicates that his/her status has changed. The current status may be e.g. that he/she is now in an important meeting and will not answer to any phone calls. The size of the presence update message may be several kbytes, e.g. 5 kbytes. In FIG. 2, only one user has subscribed to presence information of the user of user terminal 20. Therefore, a presence notification including an identifier is sent from presence server 24 to user terminal 202, as indicated with arrow 200.

The notification message does not contain the actual image received from user terminal 20. Instead, it contains an identifier for the image. The identifier refers e.g. to a hash code calculated over the image data. If receiving user terminal 202 already has an image corresponding to the received identifier in its memory, it may use it. Alternatively, if receiving user terminal 202 does not have an image corresponding to the received identifier in its memory, it sends a data content request message to presence server 24, as indicated with arrow 28. In response to the request, presence server 24 sends the image received from sending user terminal 20 to receiving user terminal 202, as indicated with arrow 200.

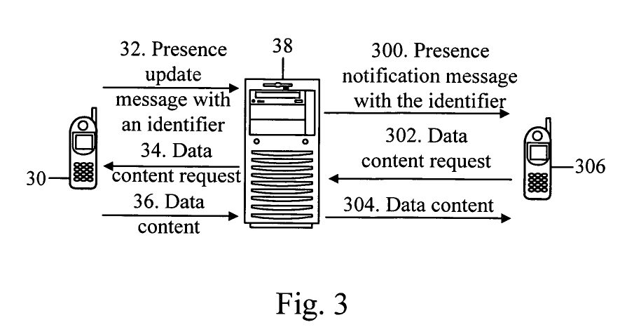

FIG. 3 comprises a sending user terminal 30, a presence server 38 and a receiving user terminal 306. User terminals 30 and 306 are connected to presence server 38. It must be noted that FIG. 3 discloses only one sending and receiving user terminal. In other embodiments, there may be any other number of them.

Sending user terminal 30 sends a presence update message including an identifier to presence server 38, as indicated with arrow 32. The identifier refers e.g. to an identifier of an image, e.g. a presence logo. The identifier may be a hash code calculated over the changed image data using e.g. the Secure Hash Algorithm (SHA-1). Any other appropriate function may also be used. With the presence update message the user of user terminal 30 indicates that his/her status has changed. The current status may be e.g. that he/she is now in an important meeting and will not answer to any phone calls. The size of the presence update message may be several kbytes, e.g. 5 kbytes.

Presence server 38 may or may not have a image corresponding to the received identifier in its memory. If such an image is not found, presence server 38 sends a data content request to sending user terminal 30, as indicated with arrow 34. In response to the request, sending user terminal 30 sends the requested data content (e.g. image) to presence server 38, as indicated with arrow 36. If such an image is found on its memory, data request 34 and response 36 are not needed.

In FIG. 3, only one user has subscribed to presence information of the user of user terminal 30. Therefore, a presence notification including an identifier is sent from presence server 38 to user terminal 306, as indicated with arrow 300.

The notification message does not contain the actual image received from sending user terminal 30. Instead, it contains an identifier for the image. The identifier refers e.g. to a hash code calculated over the image data. If receiving user terminal 306 already has an image corresponding to the received identifier in its memory, it may use it. Alternatively, if receiving user terminal 306 does not have an image corresponding to the received identifier in its memory, it sends a data content request message to presence server 38, as indicated with arrow 38. In response to the request, presence server 38 sends the image received from sending user terminal 30 to receiving user terminal 306, as indicated with arrow 304.

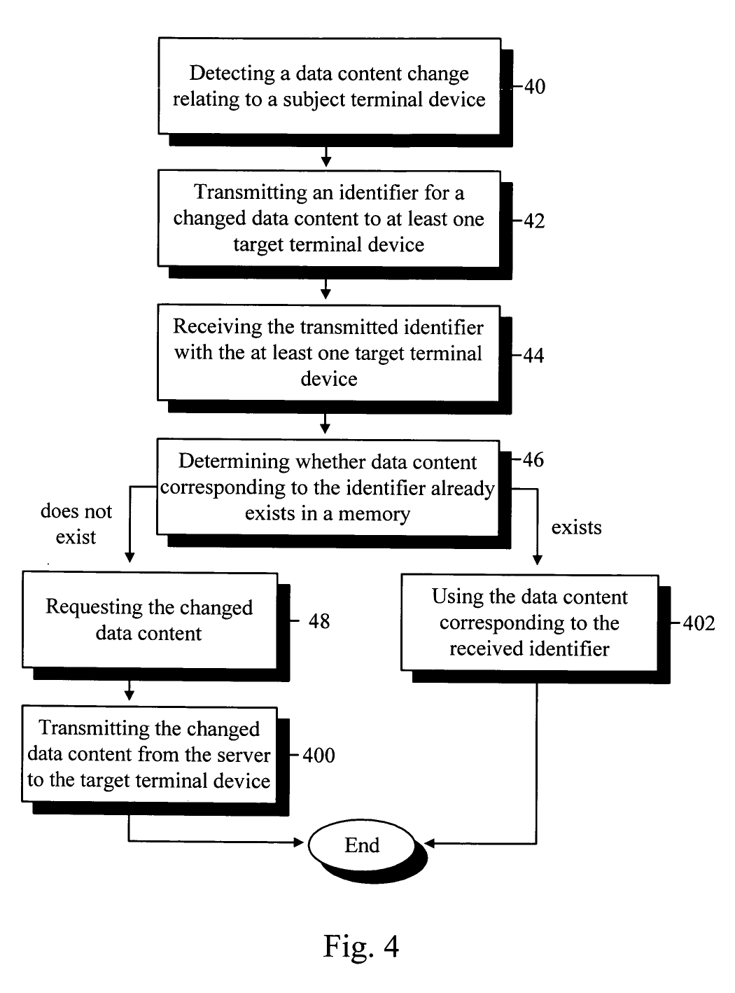

FIG. 4 discloses one embodiment of the method in accordance with the invention.

At step 40, a presence server detects a data content change relating to a subject terminal device. In one embodiment the presence server receives from the subject terminal device a presence update message including an updated data content, e.g. an image (as illustrated in FIG. 2). In another embodiment, the presence server receives from the subject terminal device only an identifier referring to the changed data content. If the presence server already has a data content corresponding to the received identifier, it may use it. If the presence server, however, does not have a data content corresponding to the received identifier, the data content is requested from the subject terminal device.

In one embodiment, the presence server calculates an identifier for the changed data content. In another embodiment, the presence server uses the identifier received from the subject terminal device. The identifier is e.g. a hash code. The changed data content refers e.g. to a changed presence logo image. Alternatively, the changed data content may refer to client device availability, user status, location, client device capabilities and searchable personal statuses, such as mood and hobbies.

The hash code is calculated over the changed data content (image data) using e.g. the Secure Hash Algorithm (SHA-1). Any other appropriate function may also be used. Hashing refers to the transformation of a string of characters into a usually shorter fixed-length value or key that represents the original string. A good hash function also should not produce the same hash value from two different inputs.

The identifier (e.g. a hash code) is then transmitted from the presence server to at least one target terminal device, as indicated at step 42. The presence server may have a list for each user, the list containing other users that have subscribed to receive presence notification messages when presence information is updated. Therefore, when a user sends a presence update message to the presence server, the presence server automatically sends presence notifications (including the identifier) to user terminals included in the list.

The presence notification message with the identifier is then received with the at least one target terminal device, as indicated at step 44. A target terminal device may have stored in its memory data contents (e.g. presence logo images etc.) used earlier in other occasions. At step 46, the target terminal determines whether data content corresponding to the identifier already exists in its memory. The memory of the target terminal device may include e.g. presence logo images used earlier. Therefore, in one embodiment an identifier is calculated for each presence logo image by calculating e.g. a hash code over the image data. In another embodiment, the presence server sends to the target terminal device also the identifier when sending a new image not contained in the memory of the target terminal device. Therefore, the target terminal device does not necessarily have to calculate the hash codes. It only compares the identifiers.

If one of the calculated or existing hash codes matches with the received one, the target terminal device already has the corresponding image data in its memory. Therefore, the target terminal device may use the image data corresponding to the received identifier, and further information from the presence server is not needed, as indicated at step 402. If, however, the target terminal device does not have the image data in its memory (based on the comparison between the received identifier and the calculated or stored identifier(s)), the target terminal device requests the changed data content (e.g. presence logo image data) from the presence server, as indicated at step 48. In response to the request, the presence server transmits the changed data content to the terminal device, as indicated at step 400.

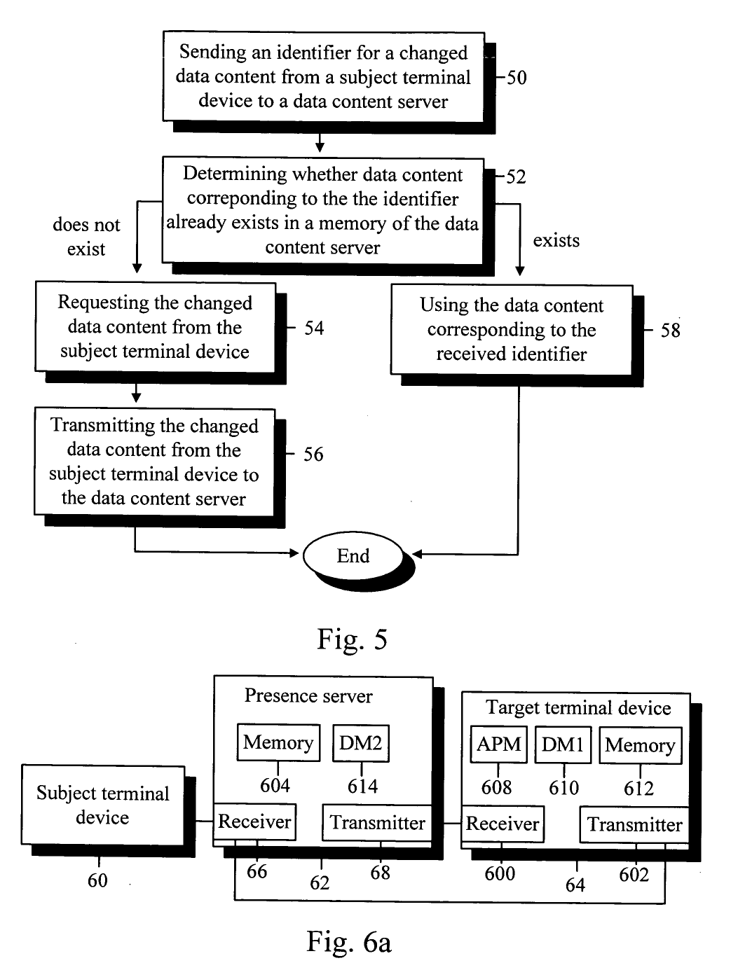

FIG. 5 discloses another embodiment of the method in accordance with the invention.

At step 50, a subject terminal device sends an identifier for a changed data content to a data content server. The changed data content refers e.g. to a changed presence logo image. Alternatively, the changed data content may refer to client device availability, user status, location, client device capabilities and searchable personal statuses, such as mood and hobbies. The identifier refers e.g. to a hash code calculated in the subject terminal device over the changed data content. The hash code is calculated over the changed data content (image data) using e.g. the Secure Hash Algorithm (SHA-1). Any other appropriate function may also be used.

The presence server receives the identifier from the subject terminal device and determines whether data content corresponding to the identifier already exists in its memory, as indicated with arrow 52. The memory of the presence server may include e.g. presence logo images used earlier. Therefore, in one embodiment an identifier is calculated for each presence logo image by calculating e.g. a hash code over the image data. In another embodiment, the presence server compares identifiers already in its memory to the received identifier. Therefore, the presence server does not necessarily have to calculate the hash codes.

If the presence server already has the data content corresponding to the received identifier, the presence server may use it, as indicated at step 58. If the presence server, however, does not have the data content (e.g. image data) in its memory (based on the comparison between the received identifier and the calculated or stored identifier(s)), the presence server requests the changed data content (e.g. presence logo image data) from the subject terminal device, as indicated at step 54. In response to the request, the subject terminal device transmits the changed data content to the presence server, as indicated at step 56.

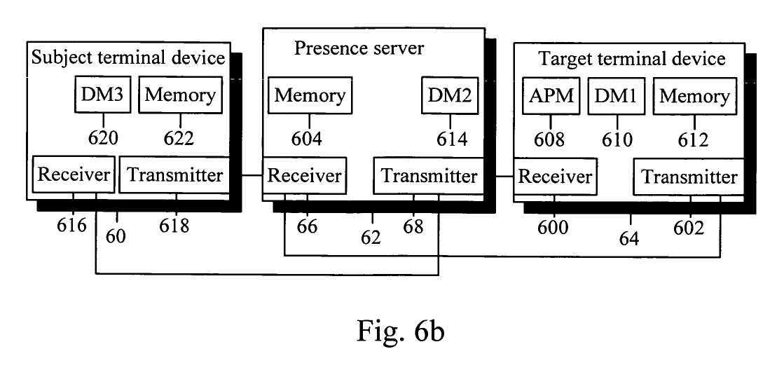

FIG. 6a discloses one embodiment of the system in accordance with the invention. The system includes a subject terminal device 60, a data content server 62 and a target terminal device 64. Data content server 62 refers e.g. to a presence server discussed earlier. Although there is only one subject terminal device, presence server and target terminal device disclosed in FIG. 6a, in other embodiments there may also be more than one such a server or terminal.

Each terminal device 60, 64 is connected to presence server 62 via a telecommunication connection (not shown). The telecommunication connection may be a circuit-switched connection or a packet-switched connection. In one embodiment the telecommunication connection is arranged via a General Packet Radio Service (GPRS) network. Other possible networks are e.g. the Wide Band Code Division Multiple Access (WCDMA) network and Enhanced Data Rates for GSM Evolution (EDGE) network.

FIG. 6a discloses only relevant elements and components so as to understand the invention. Therefore, the terminal devices and presence server may comprise also other elements, components and software applications not shown in FIG. 6a.

Presence server 62 comprises a second memory 604 configured to store a plurality of data contents, e.g. presence logo images. Presence server 62 comprises also a second receiver 66 configured to receive a data content change message, e.g. a presence update message, from subject terminal device 60. Furthermore, presence server 62 comprises second determining means 614 configured to calculate, based on data content change message, an identifier for the changed data content. The second determining means 604 refer e.g. to a processor, computer program or application or a combination of them calculating an identifier, e.g. a hash code over the changed data content. The identifier is then transmitted to target terminal device 64 using a second transmitter 68.

The changed data content refers e.g. to a changed presence logo image. Alternatively, the changed data content may refer to client device availability, user status, location, client device capabilities and searchable personal statuses, such as mood and hobbies. The identifier refers e.g. to a hash code calculated in the subject terminal device over the changed data content. The hash code is calculated over the changed data content (image data) using e.g. the Secure Hash Algorithm (SHA-1). Any other appropriate function may also be used.

Target terminal device 64 comprises a first memory 612 and a first receiver 600 configured to receive an identifier for a changed data content from presence server 62. The changed data content refers e.g. to a presence update message containing an updated presence logo image. Target terminal device 64 further comprises first determining means 610 configured to determine, based on the received identifier for the changed data content, whether data content corresponding to the identifier already exists in the first memory 612. If such a data content does not exist in the first memory 612, a transmitter 602 is configured to transmit a request for the changed data content to the second received 66 of presence server 62, whereupon the first receiver 600 receives the changed data content from presence server 62. If the data content corresponding to the identifier exists in the first memory 612, applying means 408 are configured to use the data content in the first memory 612, or to use the received changed data content received by the first receiver 600 if the changed data content did not exist in the first memory 612.

Memories 604 and 612 may consist of several different memories. Furthermore, memories 604 and 612 comprise the needed computer programs in order to achieve the functionality disclosed in the invention.

In one embodiment of FIG. 6a, subject terminal device 60 and target terminal device 64 are mobile terminals, e.g. mobile phones. In another embodiment, they may by hand-held computers, personal digital assistants or any other appropriate devices.

FIG. 6b discloses another embodiment of the system in accordance with the invention. The system includes a subject terminal device 60, a data content server 62 and a target terminal device 64. Data content server 62 refers e.g. to a presence server discussed earlier. Although there is only one subject terminal device, presence server and target terminal device disclosed in FIG. 6b, in other embodiments there may also be more than one such a server or terminal.

Each terminal device 60, 64 is connected to presence server 62 via a telecommunication connection (not shown). The telecommunication connection may be a circuit-switched connection or a packet-switched connection. In one embodiment the telecommunication connection is arranged via a General Packet Radio Service (GPRS) network. Other possible networks are e.g. the Wide Band Code Division Multiple Access (WCDMA) network and Enhanced Data Rates for GSM Evolution (EDGE) network.

FIG. 6b discloses only relevant elements and components so as to understand the invention. Therefore, the terminal devices and presence server may comprise also other elements, components and software applications not shown in FIG. 6b.

Subject terminal device 60 comprises a third memory 622 configured to store data contents, e.g. presence logo images. Subject terminal device 60 further comprises third determining means 620 configured to determine an identifier for a changed data content. The identifier is e.g. a hash code. The third determining means 622 refer e.g. to a processor, computer program or application or a combination of them. Subject terminal device 60 further comprises a third transmitter 618 configured to transmit a data content change message to a data content server, the data content change message comprising the identifier for the changed data content, and a third receiver 616 configured to receive a request for the changed data content if data content corresponding to the identifier does not exist in a second memory 604 of presence server 62. A third transmitter 618 is configured to transmit the changed data content stored in the third memory 622 to presence server 62.

The changed data content refers e.g. to a changed presence logo image. Alternatively, the changed data content may refer to client device availability, user status, location, client device capabilities and searchable personal statuses, such as mood and hobbies. The identifier refers e.g. to a hash code calculated in the subject terminal device over the changed data content. The hash code is calculated over the changed data content (image data) using e.g. the Secure Hash Algorithm (SHA-1). Any other appropriate function may also be used.

Presence server 62 comprises a second memory 604 configured to store a plurality of data contents, e.g. presence logo images. Presence server 62 comprises also a second receiver 66 configured to receive a data content change message, e.g. a presence update message, from subject terminal device 60. Furthermore, presence server 62 comprises second determining means 614 configured to determine, based on a received identifier for a changed data content, whether the data content corresponding to the identifier already exists in the second memory 604. Second determining means 604 refer e.g. to a processor, computer program or application or a combination of them calculating an identifier, e.g. a hash code over the changed data content. The identifier is then transmitted to target terminal device 64 using a second transmitter 68.

Target terminal device 64 comprises a first memory 612 and a first receiver 600 configured to receive an identifier for a changed data content from presence server 62. The changed data content refers e.g. to a presence update message containing an updated presence logo image. Target terminal device 64 further comprises first determining means 610 configured to determine, based on the received identifier for the changed data content, whether data content corresponding to the identifier already exists in the first memory 612. The first determining means refer e.g. to a processor, computer program or application or a combination of them. If such a data content does not exist in the first memory 612, a transmitter 602 is configured to transmit a request for the changed data content to the second received 66 of presence server 62, whereupon the first receiver 600 receives the changed data content from presence server 62. If the data content corresponding to the identifier exists in the first memory 612, applying means 408 are configured to use the data content in the first memory 612, or to use the received changed data content received by the first receiver 600 if the changed data content did not exist in the first memory 612.

Memories 604, 612 and 622 may consist of several different memories. Furthermore, memories 604, 612 and 622 comprise the needed computer programs in order to achieve the functionality disclosed in the invention.

In one embodiment of FIG. 6b, subject terminal device 60 and target terminal device 64 are mobile terminals, e.g. mobile phones. In another embodiment, they may by hand-held computers, personal digital assistants or any other appropriate devices.

It is obvious to a person skilled in the art that with the advancement of technology, the basic idea of the invention may be implemented in various ways. The invention and its embodiments are thus not limited to the examples described above, instead they may vary within the scope of the claims.

1. A method of updating data contents in at least one data content server, comprising the steps of:
sending a data content change message from a subject terminal device to at least one data content server, the data content change message comprising an identifier for the changed data content; and
determining in the at least one data content server, based on the received identifier for the changed data content, whether data content corresponding to the identifier already exists in its memory.

2. The method according to claim 1, wherein if the data content corresponding to the identifier does not exist in the memory of the at least one data content server, the method further comprises the steps of:
requesting the changed data content from the subject terminal device; and
transmitting the changed data content from the subject terminal device to the at least one data content server.

3. The method according to claim 1, wherein if the data content corresponding to the identifier exists in the memory of the at least one data content server, the method further comprises the step of:
using the data content corresponding to the received identifier.

4. The method according to claim 1, wherein further comprising the step of:
calculating by the subject terminal device the identifier for the changed data content using a hash code function.

5. The method according to claim 1, wherein the subject terminal device comprises a mobile phone.

6. A method of updating data contents in at least one target terminal device, comprising the steps of:
detecting a data content change relating a subject terminal device;
transmitting an identifier for a changed data content to at least one target terminal device;
receiving the transmitted identifier with the at least one target terminal device; and
determining in the at least one target terminal device, based on the received identifier for the changed data content, whether data content corresponding to the identifier already exists in its memory.

7. The method according to claim 6, wherein if the data content corresponding to the identifier does not exist in the memory of the at least one target terminal device, the method further comprises the steps of:
requesting, by the at least one target terminal device, the changed data content from the at least one data content server; and
transmitting the changed data content from the at least one data content server to the at least one target terminal device.

8. The method according to claim 6, wherein if the data content corresponding to the identifier already exists in the memory of the at least one target terminal device, the method further comprises the step of:
using the data content corresponding to the received identifier.

9. The method according to claim 6, wherein said step of detecting comprising receiving a data content change message from the subject terminal device.

10. The method according to claim 9, wherein the data content change message comprising at least one of a changed data content and an identifier for the changed data content.

11. The method according to claim 6, further comprising the step of calculating the identifier for the changed data content using a hash code function.

12. The method according to claim 6, wherein said step of determining comprising the steps of:
calculating at least one identifier for data contents stored in the memory of the at least one target terminal device; and
comparing the calculated at least one identifier to the received identifier.

13. The method according to claim 6, wherein said step of determining comprising comparing the received identifier to at least one identifier stored in the memory of the at least one target terminal device.

14. The method according to claim 6, wherein the identifier comprises a hash code.

15. The method according to claim 6, wherein the target terminal device comprises a mobile phone.

16. A target terminal device, comprising:
a first memory;
a first receiver configured to receive an identifier for a changed data content;
first determining means configured to determine, based on the received identifier for the changed data content, whether data content corresponding to the identifier already exists in the first memory;
a first transmitter configured to transmit a request for the changed data content if the data content corresponding to the identifier does not exist in the memory, wherein the first receiver is configured to receive the requested changed data content; and
applying means configured to use the data content in the first memory the identifier of which corresponds to the received identifier if the changed data content exists in the first memory, or to use the received changed data content received by the first receiver if the changed data content does not exist in the first memory.

17. The target terminal device according to claim 16, wherein the first determining means are configured to calculate at least one identifier for data contents stored in the first memory and compare the calculated at least one identifier to the received identifier.

18. The target terminal device according to claim 16, wherein the first determining means are configured to compare the received identifier to at least one identifier stored in the first memory.

19. The target terminal device according to claim 16, wherein the identifier comprises a hash code.

20. The target terminal device according to claim 16, wherein the target terminal device comprises a mobile phone.

21. A data content server for maintaining and updating data content information, wherein the server comprises:
a second memory configured to store a plurality of data contents;
a second receiver configured to receive a data content change message from a subject terminal device, the data content change message comprising at least one of a changed data content and an identifier for the changed data content; and
a second transmitter configured to transmit the identifier for the changed data content to at least one target terminal device.

22. The data content server according to claim 21, further comprising second determining means configured to determine, based on the received identifier for the changed data content, whether data content corresponding to the identifier already exists in the second memory.

23. The data content server according to claim 22, wherein if the data content corresponding to the identifier does not exist in the second memory, the second transmitter is configured to request the changed data content from the subject terminal device; and the second receiver is configured to receive the changed data content from the subject terminal device.

24. The data content server according to claim 22, wherein if the data content corresponding to the identifier exists in the second memory, the second transmitter is configured to transmit the identifier for the changed data content to at least one target terminal device.

25. The data content server according to claim 21, wherein the receiver is configured to receive a request for the changed data content from the at least one target terminal device; and the transmitter is configured to transmit the changed data content to the at least one target terminal device.

26. The data content server according to claim 22, wherein the second determining means are configured to calculate an identifier for the changed data content using a hash code function.

27. A system of maintaining and updating data contents in communication network, comprising:
at least one data content server;
at least one subject terminal device connected to the at least data content server;
at least one target terminal device connected to the at least data content server;
the at least one target terminal device comprising a first memory; a first receiver configured to receive an identifier for a changed data content; first determining means configured to determine, based on the received identifier for the changed data content, whether data content corresponding to the identifier already exists in the first memory; a first transmitter configured to transmit a request for the changed data content if data content corresponding to the identifier does not exist in the first memory, wherein the first receiver is configured to receive the requested changed data content; and applying means configured to use the data content in the first memory the identifier of which corresponds to the received identifier if the changed data content exists in the first memory, or to use the received changed data content received by the first receiver if the changed data content does not exist in the first memory; and
the at least one data content server comprising a second memory configured to store a plurality of data contents; a second receiver configured to receive a data content change message from the at least one subject terminal device, the data content change message comprising at least one of a changed data content and an identifier for the changed data content; and a second transmitter configured to transmit the identifier for the changed data content to the at least one target terminal device.

28. The system according to claim 27, wherein the data content server further comprises second determining means configured to determine, based on the received identifier for the changed data content, whether the data content corresponding to the identifier already exists in the second memory.

29. The system according to claim 27, wherein if the data content corresponding to the identifier does not exist in the second memory, the second transmitter is configured to request the changed data content from the subject terminal device; and the second receiver is configured to receive the changed data content from the subject terminal device.

30. The system according to claim 27, wherein if the data content corresponding to the identifier exists in the second memory, the second transmitter is configured to transmit the identifier for the changed data content to at least one target terminal device.

31. The system according to claim 27, wherein the first determining means are configured to calculate at least one identifier for data contents stored in the first memory and compare the calculated at least one identifier to the received identifier.

32. The system according to claim 27, wherein the first determining means are configured to compare the received identifier to at least one identifier stored in the first memory.

33. The system according to claim 27, wherein the second receiver is configured to receive a request for the changed data content from the at least one target terminal device; and the second transmitter is configured to transmit the changed data content to the at least one target terminal device.

34. The system according to claim 27, wherein the second determining means are configured to calculate an identifier for the changed data content using a hash code function.

35. The system according to claim 27, wherein the at least one subject terminal device comprises a third memory, third determining means configured to determine an identifier an identifier for a changed data content; a third transmitter configured to transmit a data content change message to the at least one data content server, the data content change message comprising the identifier for the changed data content; and a third receiver configured to receive a request for the changed data content from the at least one data content server if data content corresponding to the identifier does not exist in the second memory, wherein the third transmitter is configured to transmit the changed data content stored in the third memory to the at least one data content server.

36. The system according to claim 35, wherein the third determining means are configured to calculate an identifier for the changed data content using a hash code function.

37. The system according to claim 27, wherein the at least one of the subject terminal device and target terminal devices comprise a mobile phone.

38. A subject terminal device, comprising:
a third memory;
third determining means configured to determine an identifier for a changed data content;
a third transmitter configured to transmit a data content change message to a data content server, the data content change message comprising the identifier for the changed data content; and
a third receiver configured to receive a request for the changed data content if data content corresponding to the identifier does not exist in the memory of the data content server, wherein the transmitter is configured to transmit the changed data content stored in the third memory to the at least one data content server.

39. The subject terminal device according to claim 38, wherein the third determining means are configured to calculate an identifier for the changed data content using a hash code function.

40. The subject terminal device according to claim 38, comprising a mobile phone.

41. A computer program comprising code adapted to perform the following steps when executed on a data-processing system:
detecting a data content change relating to a subject terminal device; and
transmitting an identifier for the changed data content to at least one target terminal device.

42. The computer program according to claim 41, further adapted to perform the following steps when executed on said data-processing system:
receiving a request for the changed data content from the at least one target terminal device; and
transmitting the requested changed data content to the at least one target terminal device.

43. The computer program according to claim 41, wherein said step of detecting comprising receiving a data content change message from the subject terminal device.

44. The computer program according to claim 43, wherein the data content change message comprising at least one of a changed data content and an identifier for the changed data content.

45. The computer program according to claim 44, further comprising code adapted to perform the following step when executed on said data-processing system:
calculating an identifier for the changed data content using a hash code function.

46. The computer program according to claim 44, further comprising code adapted to perform the following step when executed on said data-processing system:
determining, based on the received identifier for the changed data content, whether data content corresponding to the identifier already exists in a memory.

47. The computer program according to claim 46, wherein if the data content corresponding to the identifier does not exist in the memory, the computer program further comprising code adapted to perform the following steps when executed on said data-processing system:
requesting the changed data content from the subject terminal device; and
receiving the changed data content from the subject terminal device.

48. The computer program according to claim 46, wherein if the data content corresponding to the identifier exists in the memory, the computer program further comprising code adapted to perform the following step when executed on said data-processing system:
using the data content corresponding to the received identifier.

49. The computer program according to claim 41, wherein said computer program is stored on a computer readable medium.

50. A computer program comprising code adapted to perform the following steps when executed on a data-processing system:
receiving an identifier for a changed data content from a data content server; and
determining, based on the received identifier for the changed data content, whether data content corresponding to the identifier already exists in a memory;
wherein if the data content corresponding to the identifier does not exist in the memory, requesting the changed data content corresponding to the received identifier from the data content server; and
wherein if the data content corresponding to the identifier already exists in the memory, using the data content corresponding to the received identifier.

51. The computer program according to claim 50, further comprising code adapted to perform the following steps when executed on said data-processing system:
calculating at least one identifier for data contents stored in the memory of the at least one target terminal device; and
comparing the calculated at least one identifier to the received identifier.

52. The computer program according to claim 50, wherein said step of determining comprising comparing the received identifier to at least one identifier stored in the memory of the at least one target terminal device.

53. The computer program according to claim 50, wherein said computer program is stored on a computer readable medium.

54. The computer program according to claim 50, wherein the identifier comprises a hash code.

55. A computer program comprising code adapted to perform the following step when executed on a data-processing system:
sending a data content change message comprising an identifier for the changed data content to a data content server.

56. The computer program according to claim 55, further comprising code adapted to perform the following step when executed on said data-processing system:
calculating the identifier for the changed data content using a hash code function.

57. The computer program according to claim 55, further comprising code adapted to perform the following steps when executed on said data-processing system:
receiving a request for the changed data content from the data content server; and
transmitting the changed data content to the data content server.

58. The computer program according to claim 55, wherein said computer program is stored on a computer readable medium.
